(19) United States
(12) Patent Application Publication
(10) Pub. No.: US 2023/0109044 A1
(43) Pub. Date: Apr. 6, 2023

(54) FEEDBACK VIA MECHANICAL IMAGING COMPONENTS

(71) Applicant: Hewlett-Packard Development Company, L.P., Spring, TX (US)

(72) Inventors: Wei Lit Teoh, Singapore (SG); Choon Siang Peck, Singapore (SG); Ginu Jacob, Ernakulam (IN); Yaw Wai Lau, Singapore (SG); Kong Ngee Kelvin Foo, Singapore (SG)

(21) Appl. No.: 17/790,300

(22) PCT Filed: Apr. 13, 2020
(86) PCT No.: PCT/US2020/027969

§ 371 Date: Jun. 30, 2022

(51) Int. Cl. B41J 29/393; G06F 3/01

(52) U.S. Cl. CPC B41J 29/393; G06F 3/016

(57) ABSTRACT

An apparatus and/or method may be implemented in accordance with aspects characterized herein. A controller may identify a state of an image forming apparatus and generate feedback signals to instruct a mechanical actuator, which moves an imaging component of an image forming apparatus to indicate the state. Accordingly, mechanical printing type componentry, such as linear, rotary, print head or scanning mechanisms, may be utilized for carrying out printing-related functions and to generate audible, visual and/or haptic feedback.

### BACKGROUND

Communicating between printers and other devices and users of those devices may require various resources, such as software and hardware resources dedicated to providing sound, light or other type of user feedback. Visual devices such as LEDs or indicators on touch screens, audio devices such as speakers, or haptic devices such as motors or piezoelectric actuators may be employed along with appropriate circuitry to control feedback relative to operation of the printer or inputs.

### BRIEF DESCRIPTION OF FIGURES

Various examples may be more completely understood in consideration of the following detailed description in connection with the accompanying drawings, in which:

FIG. 1 is a diagram illustrating an example apparatus involving the generation of feedback via actuation of printer mechanics, in accordance with the present disclosure;

FIG. 2 is a data flow diagram illustrating an approach to the generation of feedback via actuation of printer mechanics, in accordance with the present disclosure;

FIG. 3 is a diagram illustrating a printer apparatus and related componentry for the generation of feedback via actuation of printer mechanics, in accordance with the present disclosure; and

FIG. 4 depicts a non-transitory computer-readable medium and related processing circuitry for generating feedback via actuation of printer mechanics, in accordance with the present disclosure.

### DETAILED DESCRIPTION

Aspects of the present disclosure are directed to addressing issues relating to operation and feedback with imaging devices, such as printers and scanners. Some examples are directed to apparatuses and methods involving the use of mechanical components, such as those used to print or scan documents, or to print 3D structures, to generate user feedback. Such components may, for example, utilize motors, actuators or other components that generate a detectable output. This detectable output may be used to provide haptic, audio or visual feedback. This feedback may be provided for actions as may relate to touching a screen or button, making a type of operational instruction, or providing information concerning a process such as to indicate that a print or scan job is complete or has experienced an error. Accordingly, mechanical components that are to effect printing or scanning may be separately utilized to create sound, vibration or other user feedback, which may be carried out independently from printing or scanning operations.

In accordance with an example, a controller is to identify a state of an image forming apparatus, and to generate feedback signals to instruct a mechanical actuator, which is to move an imaging component of an image forming apparatus, to indicate the state. Accordingly, various aspects may utilize mechanical printing type componentry, such as linear, rotary, print head or scanning mechanisms for carrying out printing-related functions, to generate audible, visual and/or haptic feedback. Such feedback may be generated via mechanical actuation that is part of, or independent from, actual printing activity. For instance, a scanner carriage for moving an imaging component, or printer actuators for a paper drive and carriage drive, may be used in this regard. An auto-document feeder may be utilized for providing rotary motion that may exhibit various speeds and, in some instances, variable speeds for providing different types of sounds, rotation in different directions, and/or a constant/infinity type rotational motion in a single direction.

In various contexts, control logic may generate feedback by moving componentry within specifications thereof, for speed and movement. In some examples, componentry is actuated in a manner different from a manner utilized for effecting printing functions. For instance, components that rotate in a single direction for print functions may be rotated in an opposite direction. Low-latency interfacing circuitry may be utilized to facilitate the presentation of feedback as an immediate or near immediate response (for example, less than 100ms). Desired feedback, such as audible or haptic feedback, may be converted into motion commands by an offline-compile tool or a runtime-interpreter tool, such as to provide a musical or otherwise discernable sound.

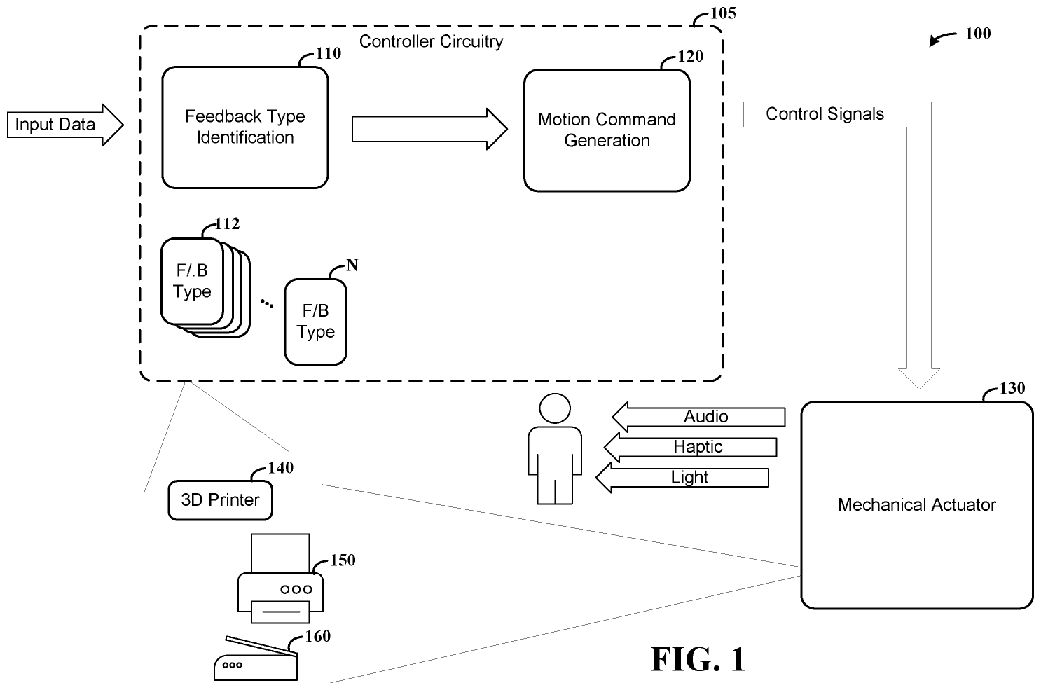

Turning to the Figures, FIG. 1 is a diagram illustrating an example apparatus 100 involving the generation of feedback via actuation of printer mechanics, in accordance with the present disclosure. The apparatus 100 may include a feedback identification block 110 that may identify a type of feedback to be provided, and a motion command generation block 120 that may generate motion or other control signals for controlling a mechanical actuator 130. The feedback type identification block 110 may be referred to as feedback circuitry characterized herein, and the motion command generation block 120 may be implemented as part of an imaging circuit. These blocks may be implemented together as controller circuitry 105, as may be further utilized within a printing apparatus. For instance, the input data and resulting feedback generation may be provided relative to different types of components, with example components shown as a 3D printer 140, document printer 150 and scanner 160.

The feedback identification block 110 may identify feedback types based on input data received from a variety of sources. For instance, feedback may be identified for a variety of different user inputs that may be received, such as to acknowledge a touch via haptic feedback, or to acknowledge a selected function by providing audio from one of the components. The feedback type may be chosen from feedback types data 112-N, which may include information for defining motion to effect the feedback type.

Motion command generation block 120 may respond to an input from the feedback type identification block 110 by generating specific control signals that cause the mechanical actuator 130 to move in a manner that provides user feedback. Such feedback may include audio or haptic feedback that results from mechanical movement, or light feedback such as by causing an optical scanning component to illuminate.

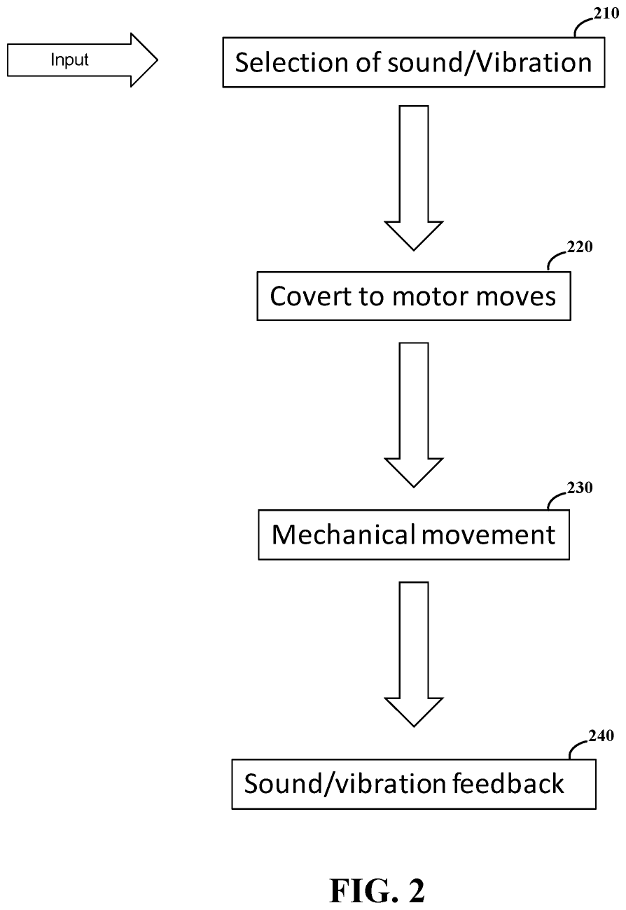

FIG. 2 is a data flow diagram illustrating an approach to the generation of feedback via actuation of printer mechanics for audio and/or haptic feedback, in accordance with the present disclosure. At block 210, a type sound or vibration feedback is selected to indicate an event. This may, for example, involve the generation of what are effectively lyrics or a musical tune. At block 220, this selected type of feedback is converted to motor moves, such as to control movement of speed, duration and direction. These motor moves are then used to direct mechanical movement at block 230, which in turn generates sound or vibration feedback at block 240. By way of example, events for which feedback may be provided may include power up, end of print job, press of a button, end of a scan, document loading, an open or close of a paper tray or access panel, amongst others.

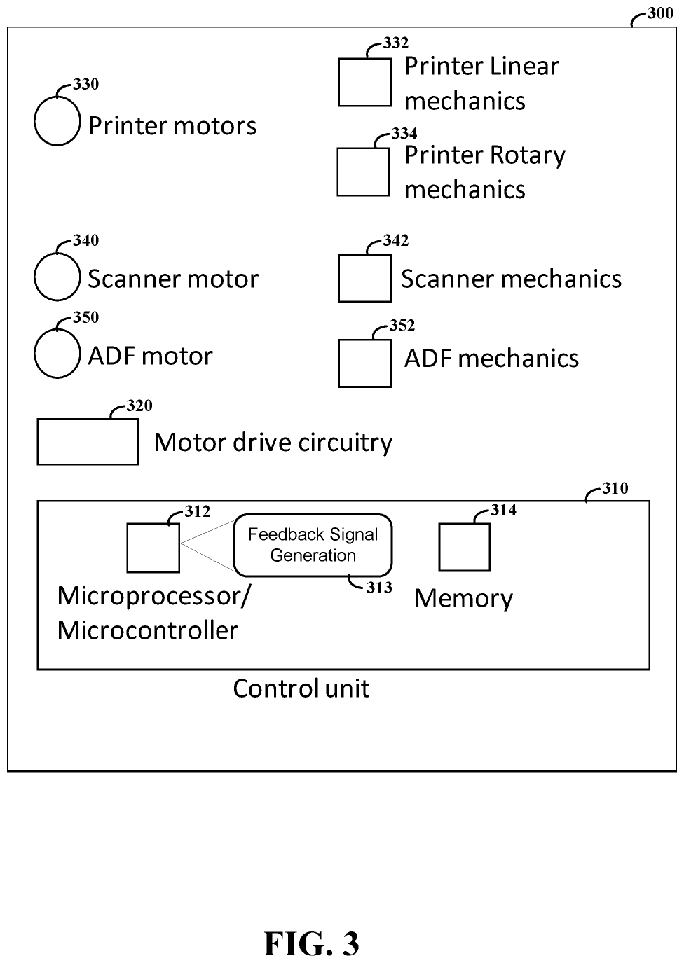

FIG. 3 shows an apparatus 300 as may be implemented for generating feedback utilizing printer mechanics, in accordance with an example or examples. The apparatus includes control unit 310 having imaging circuitry including a microprocessor/controller 312 with related feedback signal generation 313, and memory 314. Motor drive circuitry 320 may generate motor drive instructions that provide functions such as printing and scanning functions, as well as instructions that provide feedback. The apparatus 300 may include printer componentry, scanner componentry, or both printer and scanner componentry.

By way of example, componentry for both printing and scanning functions, as well as componentry for document feeding functions, are shown. However, less than all such componentry may be utilized in certain examples. Accordingly, the apparatus 300 may include printer motors 330 and one or both of printer linear mechanics 332 and printer rotary mechanics 334. The apparatus 300 may include scanner motor 340 and scanner mechanics 342. The apparatus 300 may include an automatic document feeder (ADF) motor 350 and ADF mechanics 352. Motor drive circuitry 320 may thus control printer motors 330, scanner motor 340, and ADF motor 350.

In accordance with an example, the apparatus 300 may operate as follows. When the control unit 310 receives an input representing an event, it checks a list of different types of audio feedback stored in its memory 314 and selects audio feedback specific to the event received. The selected audio feedback is converted to determine a motor or combination of motors to be operated. The audio feedback may be converted to specific motor moves, which may include speed, duration, and direction at which the motor needs to be operated. The control unit drives the specific motor or the combination of motors by changing the input to the motor or motor drive circuitry to achieve the specific moves. The generated motor movement may or may not result in moving the mechanics, for instance in which an audible actuation is generated by moving a motor without moving related mechanics. In various examples, the motor may move itself or the cause mechanics to move and generate sounds and/or vibrations. For instance, the motor may be energized without engaging a mechanical output with another mechanical component that is to move in response to the mechanical output. Resulting sounds and/or vibrations generated are used as feedback to intimate a specific even to a user.

Certain examples involve a non-transitory computer-readable medium having instructions stored therein that, in response to being executed on computer circuitry, cause the computer circuitry to execute instructions to operate printing componentry. For instance, such a non-transitory computer-readable medium may operate via controller circuitry to identify a state of an image forming apparatus and to indicate the state by generating feedback signals that instruct a mechanical actuator to move an imaging component of an image forming apparatus. Accordingly, various aspects may utilize such non-transitory computer-readable medium for controlling mechanical printing type componentry for carrying out printing-related functions, to effect additional functionality for generating audible, visual and/or haptic feedback. Such feedback may be generated via mechanical actuation that is part of, or independent from, actual printing activity.

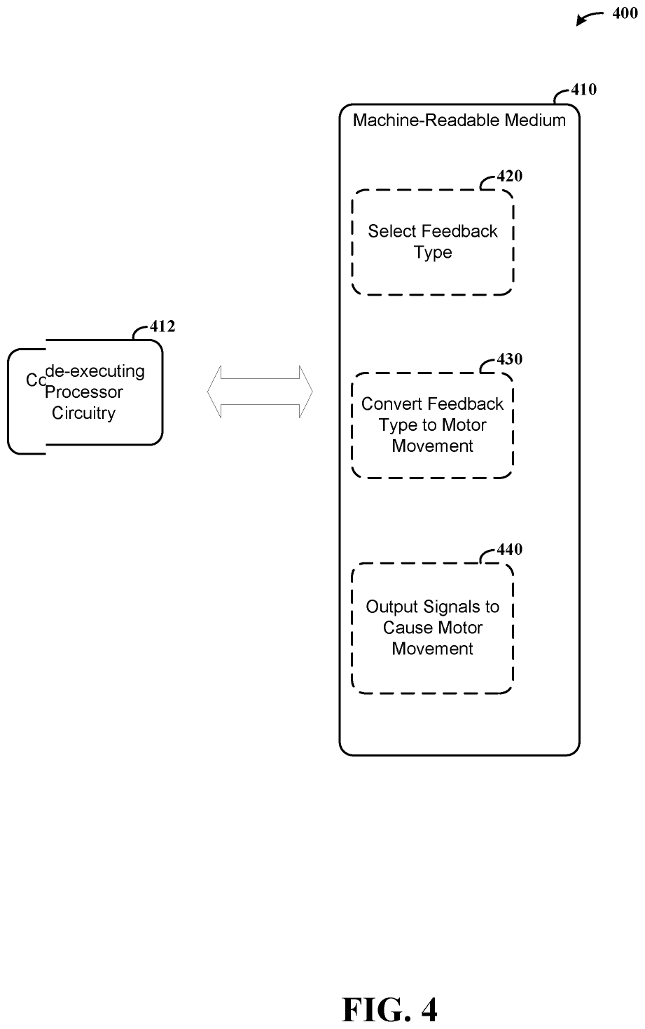

FIG. 4 depicts an example non-transitory machine-readable medium 410 and related processing circuitry 412 for generating feedback via actuation of printer mechanics, in accordance with the present disclosure. The machine-readable medium 410 may include a variety of instructions stored thereon, which carry out specific functions when executed on code-executing processor circuitry (412). By way of example, instruction block 420 is depicted for selecting a feedback type, instruction block 430 is depicted for converting the feedback type to motor movement, and instruction block 440 is depicted for outputting signals to cause motor movement. The machine-readable medium 410 and processing circuitry 412 may be implemented together as a common apparatus 400.

The following examples may be implemented in connection with the figures, in manners that may use other approaches not shown in the figures, or in a combination of manners with some aspects as depicted in one of figures and other aspects as depicted in other figures or otherwise.

In an example, an image-forming apparatus includes a mechanical actuator to move an imaging component of the image forming apparatus, imaging circuitry to control the mechanical actuator via imaging signals to generate an image by moving the imaging component, and feedback circuitry to generate audio or vibrational user feedback by controlling the mechanical actuator via feedback signals for moving the imaging component. For instance, a mechanical actuator such as a motor may provide feedback via audible sound or vibration. A mechanical actuator in this context may also include further componentry, such as a linear or rotating component that moves using an input from a motor. As such, a mechanical actuator may be a motor, a mechanical component moved by such a motor, or both a motor and a mechanical component that it moves.

The feedback circuitry may generate different types of audio or vibrational user feedback by selecting one of a plurality of different types of audio or vibrational user feedback, converting the selected one of the plurality of different types of audio or vibrational user feedback into movements of the mechanical actuator, and generating the feedback signals to control the mechanical actuator to carry out the movements.

The imaging component may include a variety of mechanisms. For instance, the imaging component may include linear mechanisms that may include sensor arrays mounted in a sliding carriage mechanism, service station wiring systems mounted on a rack and pinion drive, rotary mechanisms such as pneumatic and fluidic pump systems for ink delivery; and fans for generating internal positive pressures/favorable airflow. In one example, the mechanical actuator is to move the imaging component by moving a print head relative to a target upon which the image is to be formed. In another example, the mechanical actuator is to move the imaging component by moving a target upon which the image is to be formed. In a further example, the mechanical actuator is to move the imaging component by moving a scanner relative to a target image for imaging the target image. The mechanical actuator may move the imaging component by moving a target image relative to a scanner for imaging the target image. These examples may be combined, for applications.

The feedback circuitry may operate in a variety of manners. For instance, the feedback circuitry may generate different types of feedback, based on operational characteristics of the image-forming apparatus, by generating the audio or vibrational user feedback. This feedback may be effected by controlling the mechanical actuator via different feedback signals for each respective type of feedback. The feedback circuitry and imaging circuitry may be included in a common circuit, the common circuit being to send the imaging signals separately from the feedback signals. The feedback circuitry may generate and apply the feedback signals separately from the imaging signals. The feedback circuitry may control the mechanical actuator via feedback signals to generate audio or vibrational user feedback by moving the imaging component separately from movement of the imaging component for forming the image.

In another example, a method is carried out as follows. A state of an image forming apparatus is identified, the apparatus having a mechanical actuator and an imaging component. The identified state is indicated by generating and using feedback signals to instruct the mechanical actuator to indicate the state by moving the imaging component. Generating and using the feedback signals may include selecting one of a plurality of different types of audio or vibrational user feedback, converting the selected one of the plurality of different types of audio or vibrational user feedback into movements of the mechanical actuator, and generating the feedback signals to control the mechanical actuator to carry out the movements. An image may be generated by controlling the mechanical actuator to move the imaging component, such as to print an image on a document or print a 3D structure. The identified state may be indicated by moving the mechanical actuator to move a component selected from the group of: a print head, a scanner, a target upon which an image is to be formed, a target image relative to a scanner for imaging the target, and a combination thereof.

In the description herein, various specific details are set forth to describe specific examples. However, other examples and/or variations of these examples may be practiced without all the given details. In other instances, features have not been described in detail so as not to obscure the description of the examples herein. For instance, a variety of computer operating systems, logic circuitry (which may refer to or include a code-programmed/configured CPU), hardware, BIOS or UEFI functions, printer types, and memory types may be utilized in connection with examples characterized herein, such as to carry out various methods, operations and activities. In addition, although aspects and features may be described in individual figures in some cases, features from one figure or example may be combined with features of another figure or example even though the combination is not explicitly shown or explicitly described as a combination. For instance, various method-based aspects may be implemented in connection with the apparatuses depicted in FIGS. 1 and 3. As another example, various circuit blocks or modules as characterized in the figures may be combined into a common circuit, or implemented with separate circuitry.

What is claimed is:

1. An image-forming apparatus comprising:
a mechanical actuator to move an imaging component of the image forming apparatus;
imaging circuitry to control the mechanical actuator via imaging signals to generate an image by moving the imaging component; and
feedback circuitry to generate audio or vibrational user feedback by controlling the mechanical actuator via feedback signals to move the imaging component.

2. The apparatus of claim 1, wherein the feedback circuitry is to:
select one of a plurality of different types of audio or vibrational user feedback;
convert the selected one of the plurality of different types of audio or vibrational user feedback into movements of the mechanical actuator; and
generate the feedback signals to control the mechanical actuator to carry out the movements.

3. The apparatus of claim 1, wherein the mechanical actuator is to move a print head relative to a target upon which the image is to be formed.

4. The apparatus of claim 1, wherein the mechanical actuator is to move a target upon which the image is to be formed.

5. The apparatus of claim 1, wherein the mechanical actuator is to move a scanner relative to a target image to image the target image.

6. The apparatus of claim 1, wherein the mechanical actuator is to move a target image relative to a scanner to image the target image.

7. The apparatus of claim 1, wherein the feedback circuitry is to control the mechanical actuator via different feedback signals for each respective type of feedback to generate different types of audio or vibrational user feedback based on characteristics of the image- forming apparatus.

8. The apparatus of claim 1, wherein the feedback circuitry and imaging circuitry are included in a common circuit, the common circuit being to send the imaging signals separately from the feedback signals.

9. The apparatus of claim 1, wherein the feedback circuitry is to generate and apply the feedback signals separately from the imaging signals.

10. The apparatus of claim 1, wherein the feedback circuitry is to control the mechanical actuator via feedback signals to generate audio or vibrational user feedback, and to move the imaging component separately from movement of the imaging component to form the image.

11. An apparatus comprising:
a mechanical actuator to move an imaging component of an image forming apparatus; and
a controller to:
identify a state of the image forming apparatus; and
generate feedback signals to instruct the mechanical actuator to indicate the state.

12. A method comprising:
identifying a state of an image forming apparatus having a mechanical actuator and an imaging component; and
indicating the identified state by generating and using feedback signals to instruct the mechanical actuator to indicate the state by moving the imaging component.

13. The method of claim 12, further including generating an image by controlling the mechanical actuator to move the imaging component.

14. The method of claim 12, wherein generating and using the feedback signals includes:
selecting one of a plurality of different types of audio or vibrational user feedback;
converting the selected one of the plurality of different types of audio or vibrational user feedback into movements of the mechanical actuator; and
generating the feedback signals to control the mechanical actuator to carry out the movements.

15. The method of claim 12, wherein indicating the identified state includes moving the mechanical actuator to move a component selected from the group of: a print head, a scanner, a target upon which an image is to be formed, a target image relative to a scanner to image the target, and a combination thereof.
